(19) United States
(12) Patent Application Publication
(10) Pub. No.: US 2024/0005240 A1
(43) Pub. Date: Jan. 4, 2024

(54) METHOD AND DEVICE FOR PROVIDING COMPRESSED GIG SERVICE

(71) Applicant: ENTERPRISE BLOCKCHAIN CO., LTD., Seoul (KR)

(72) Inventors: Youngseok HAN, Hwaseong-si (KR); Jihyun LEE, Yongin-si (KR); Yongwook KIM, Seoul (KR); Donghyun KIM, Yongin-si (KR); Junsup LEE, Seoul (KR); Nayoung YOUK, Seoul (KR); Taeho GWAK, Seoul (KR)

(73) Assignee: ENTERPRISE BLOCKCHAIN CO., LTD., Seoul (KR)

(21) Appl. No.: 18/265,056

(22) PCT Filed: Nov. 12, 2021
(86) PCT No.: PCT/KR2021/016540

§ 371 Date: Jun. 2, 2023

(30) Foreign Application Priority Data
Dec. 17, 2020 (KR) 10-2020-0177012

(51) Int. Cl. G06Q 10/0631

(52) U.S. Cl. CPC G06Q 10/06315

(57) ABSTRACT

Disclosed are a method for providing a compressed gig service and a device therefor, the method comprising the steps of: obtaining compressed gig service information including service content, service time, and service area; predicting an order amount for the compressed gig service information; determining the price for the compressed gig service information on the basis of the compressed gig service information and the order amount; generating a gig service offer including the compressed gig service information and a gig service price; and transmitting the gig service offer to at least one gig service requester terminal.

### TECHNICAL FIELD

The present invention relates to a compressed gig service providing method and device, and more particularly, to a compressed gig service providing method and device, being capable of learning existing gig service request data to predict future gig service information, obtaining prediction information having an occurrence probability greater than or equal to a predetermined value amongst the predicted information as compressed gig service information, and providing at least one gig service requester terminal with a gig service offer, the gig service offer including compressed gig service information and a gig service price through order quantity prediction and price determination, thereby enabling a gig worker to receive multiple gig service orders to maximize the quantity of gig service orders and the price competitiveness.

### BACKGROUND ART

Along with vitalization of on-demand economy, the gig economy is emerging as a new labor trend, as the labor demand required for on-demand services increases as well. The gig economy refers to an economy in which business entities (or gig service providers) recruit and pay for short-term contract workers or temporary jobs as needed. Here, the term ‘gig’ refers to a temporary work. The term ‘gig’ or ‘gig worker’ was used in the past to encompass various freelancers and a single-person self-employed worker, but as the on-demand economy spreads, it has recently changed to refer to a service supplier who provide a service in the form of short-term contract with on-line platform business entities or non-regular workers equivalent to a private business entity.

The existing employment system is commonly in the form of a business entity or company directly hiring employees, signing formal labor contracts with them, and providing products or services to its customers with its own labor force. On the other hand, in the gig economy, companies use gig workers in the form of ultra-short-term contracts according to demands as required. In the gig economy system, those gig workers are not employed by someone, and they are temporarily employed only as much as they want to at any desired time when necessary, thereby generating their income through the labor desired by the customers, that is, the gig service requesters.

A gig platform refers to a platform adapted to receive a gig service order from a gig service requester and request a service from a corresponding gig worker, and a gig platform operator refers to a business operator that provides a gig platform service. Gig workers may sometimes compete with other gig workers for job demand upon receiving jobs through the gig platform and performing the gig services.

In order to increase the productivity of gig workers on the gig platform, there have been some attempts to handle the gig service orders in bundle or optimize the delivery order and schedule. However, it may be not easy to increase the productivity of gig workers for the orders that have already occurred due to topographical characteristics and order dispersion.

Therefore, it is necessary to improve degree of completion of the gig services by increasing the productivity of gig workers on the gig platform to maximize profits and at the same time reducing the costs of gig service requesters, and so on, for increasing satisfaction of the parties concerned.

### DETAILED DESCRIPTION OF THE INVENTION

### Technical Problem

The present invention is to address the above-described technical problems, and the present invention aims to substantially compensate for various problems caused by limitations and disadvantages in the related art, and to provide a compressed gig service providing method and device, being capable of learning existing gig service request data to predict future gig service information, obtaining prediction information having an occurrence probability greater than or equal to a predetermined value amongst the predicted information as compressed gig service information, and providing at least one gig service requester terminal with a gig service offer, the gig service offer including compressed gig service information and a gig service price through order quantity prediction and price determination, thereby enabling a gig worker to receive multiple gig service orders to maximize the quantity of gig service orders and the price competitiveness. Further, the present invention aims to provide a computer-readable recording medium having recorded thereon a program for executing the method.

### Technical Solution

According to an embodiment of the disclosure, a method for providing a compressed gig service comprises: obtaining compressed gig service information including a service content, a service time, and a service area; predicting an order amount for the compressed gig service information; determining a gig service price for the compressed gig service information, based on the compressed gig service information and the order amount; generating a gig service offer including the compressed gig service information and the gig service price; and transmitting the gig service offer to at least one gig service requester terminal.

According to an embodiment of the disclosure, obtaining the compressed gig service information comprises obtaining and storing first gig service request data from the gig service requester terminal, and generating a learning model by deep learning the at least one first gig service request data.

According to an embodiment of the disclosure, obtaining the compressed gig service information comprises predicting at least one future gig service information, based on the learning model, and generating the future gig service information having an occurrence probability equal to or greater than a predetermined value among the at least one future gig service information, as the compressed gig service information.

According to an embodiment of the disclosure, the first gig service request data comprises at least one of a service content, a service request time, a service request area, and service requester information.

According to an embodiment of the disclosure, predicting an order amount for the compressed gig service information comprises predicting the order amount for the compressed gig service information based on the learning model.

According to an embodiment of the disclosure, the method for providing the compressed gig service further comprises receiving second gig service request data for the gig service offer from the gig service requester terminal, and processing the gig service for the received second gig service request data.

According to an embodiment of the disclosure, the method for providing the compressed gig service further comprises updating the learning model, based on the second gig service request data.

According to an embodiment of the disclosure, the method for providing the compressed gig service further comprises generating a work schedule of a gig worker to handle the gig service, based on the second gig service request data.

According to an embodiment of the disclosure, the method for providing the compressed gig service further comprises receiving a bid for a gig service price from at least one gig worker capable of processing the gig service, based on the second gig service request data, and selecting a gig worker who has offered a lowest price among the bids for the gig service price, as the gig worker to handle the gig service.

According to an embodiment of the disclosure, obtaining the compressed gig service information further comprises receiving second gig service information from the gig service requester terminal, determining, based on the learning model, whether an occurrence probability of the second gig service information is greater than or equal to a predetermined value, and in a case of the occurrence probability of the second gig service information being greater than or equal to a predetermined value, generating the second gig service information as the compressed gig service information.

Further, according to an embodiment of the disclosure, provided is a computer-readable recording medium having recorded thereon a program for performing the method.

Further, according to an embodiment of the disclosure, a device for providing a compressed gig service comprises: a gig service compression unit configured to obtain compressed gig service information including a service content, a service time, and a service area; an order amount prediction unit configured to predict an order amount for the compressed gig service information; a price determination unit configured to determine a price for the compressed gig service information, based on the compressed gig service information and the order amount; an offer generation unit configured to generate a gig service offer including the compressed gig service information and the gig service price; and an offer transmission unit configured to transmit the gig service offer to at least one gig service requester terminal.

According to an embodiment of the disclosure, the gig service compression unit comprises a gig service request data acquisition unit configured to acquire and store first gig service request data from the gig service requester terminal, and a learning model generation unit configured to generate a learning model by deep learning the at least one first gig service request data.

According to an embodiment of the disclosure, the gig service compression unit further comprises a gig service information prediction unit configured to predict at least one future gig service information, based on the learning model, and a first compression generation unit configured to generate future gig service information having an occurrence probability equal to or greater than a predetermined value among the at least one future gig service information, as the compressed gig service information.

According to an embodiment of the disclosure, the first gig service request data comprises at least one of a service content, a service request time, a service request area, and service requester information.

According to an embodiment of the disclosure, the order amount prediction unit predicts an order amount for the compressed gig service information, based on the learning model.

According to an embodiment of the disclosure, the gig service request data acquisition unit receives second gig service request data for the gig service offer from the gig service requester terminal, and the compressed gig service providing device further comprises a gig service processing unit configured to handle the gig service for the received second gig service request data.

According to an embodiment of the disclosure, the compressed gig service providing device further comprises a learning model updating unit configured to update the learning model, based on the second gig service request data.

According to an embodiment of the disclosure, the compressed gig service providing device further comprises a work schedule generation unit configured to generate a work schedule of a gig worker to handle the gig service, based on the second gig service request data.

According to an embodiment of the disclosure, the compressed gig service providing device further comprises a price bidding unit configured to receive a bid for a gig service price from at least one gig worker capable of handling the gig service, based on the second gig service request data, and a gig worker selection unit configured to select a gig worker who has offered a lowest price among the bids for the gig service price, as the gig worker to handle the gig service.

According to an embodiment of the disclosure, the gig service compression unit further comprises a gig service information receiving unit configured to receive second gig service information from the gig service requester terminal, and a second compression generation unit configured to determine whether an occurrence probability of the second gig service information is greater than or equal to a predetermined value, based on the learning model, and generate the second gig service information as the compressed gig service information in case that the occurrence probability of the second gig service information is greater than or equal to the predetermined value.

### Advantageous Effects

According to the disclosure, the method for providing a compressed gig service can perform a learning of the existing gig service request data to predict future gig service information, and obtaining prediction information having an occurrence probability greater than or equal to a predetermined value, amongst the predicted information, as compressed gig service information, to provide a plurality of gig service requesters with a gig service offer, thereby maximizing the number of orders handled by the gig worker per hour for the compressed gig service and improving the efficiency of the gig service. Thus, according to the disclosure, it is possible to maximize the productivity of a gig worker by inducing generation of orders from a plurality of gig service requesters based on the compressed gig service information. According to the disclosure, the method for providing a compressed gig service makes it possible to reduce the service unit by compression and increase the size (order quantity) of the compressed service, thereby providing the gig service at a lower price and maximizing the profit due to increase in productivity of the gig worker.

### BRIEF DESCRIPTION OF DRAWINGS

FIG. 1 is a schematic configuration diagram illustrating a compressed gig service providing system according to an embodiment of the disclosure.

FIG. 2 is a schematic flowchart of a method for providing a compressed gig service according to an embodiment of the disclosure.

FIG. 3 is a schematic flowchart of obtaining compressed gig service information according to an embodiment of the disclosure.

FIG. 4 is a schematic flowchart of obtaining compressed gig service information according to another embodiment of the present invention.

FIG. 5 is a schematic block diagram of a compressed gig service providing device according to an embodiment of the disclosure.

FIG. 6 is a schematic block diagram of a gig service compression unit according to an embodiment of the disclosure.

FIG. 7 is a schematic block diagram of a gig service compression unit according to another embodiment of the present invention.

### MODE FOR CARRYING OUT THE INVENTION

Hereinafter, preferred embodiments of the present disclosure will be described in detail with reference to the accompanying drawings. Throughout the drawings, like or same reference numerals refer to like or same elements, and the size of each component therein may be exaggerated or reduced for better clarity of description.

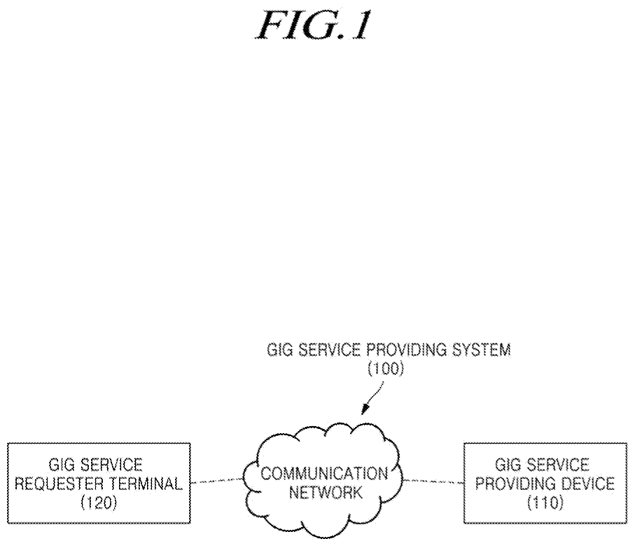

FIG. 1 is a schematic block diagram illustrating a compressed gig service providing system according to an embodiment of the disclosure.

A gig service providing system 100 according to an embodiment of the disclosure includes at least one gig service providing device 110 and at least one gig service requester terminal 120.

The gig service providing device 110 according to the embodiment generates a learning model by learning gig service request data from at least one gig service requester terminal 120. The gig service providing device 110 predicts future gig service information based on the learning model, obtains prediction information having an occurrence probability equal to or greater than a predetermined value among the predicted information, as compressed gig service information, and provides a gig service offer to at least one gig service requester terminal 120. According to the embodiment, the system 100 may include a plurality of gig service requester terminals 120, and as the number of gig service requester terminals 120 increases and the accumulated gig service request data increases, the prediction accuracy of future gig service information may be increased.

The gig service request data and the compressed gig service information according to the embodiment include at least three service elements consisting of a service content, a service time, and a service area. In obtaining the compressed gig service information according to the embodiment, it will be apparent to those skilled in the art that there is no limitation on the elements to be compressed and the number thereof, such as e.g., constantizing one element of the three service elements and compressing the remaining two elements, constantizing two elements and compressing the remaining one element, or compressing the three elements without constantizing any elements. The gig service providing device 110 according to the embodiment may obtain, as compressed gig service information, a section in which the three elements are most aggregated, that is, a section having the highest probability of a set of three elements, from among the predicted future gig service information, but it will be obvious to those skilled in the art that another algorithm capable of compressing the gig service information may be utilized.

The gig service providing device 110 according to the embodiment predicts an order amount for the compressed gig service information based on the learning model. The gig service providing device 110 determines a price for the compressed gig service information, based on the compressed gig service information and the order amount. The gig service offer includes the compressed gig service information and the determined gig service price.

The gig service providing device 110 according to the embodiment may provide a gig service offer based on the compressed gig service information to at least one gig service requester terminal 120, thereby inducing generation of an order from a plurality of gig service requesters and maximizing productivity of the gig worker. That is, the method for providing the compressed gig service according to the embodiment can reduce the service unit by compression, increasing the size (order amount) of the compressed service, and thus, providing the gig service at a lower price, thereby increasing the productivity of the gig workers to maximize their profits.

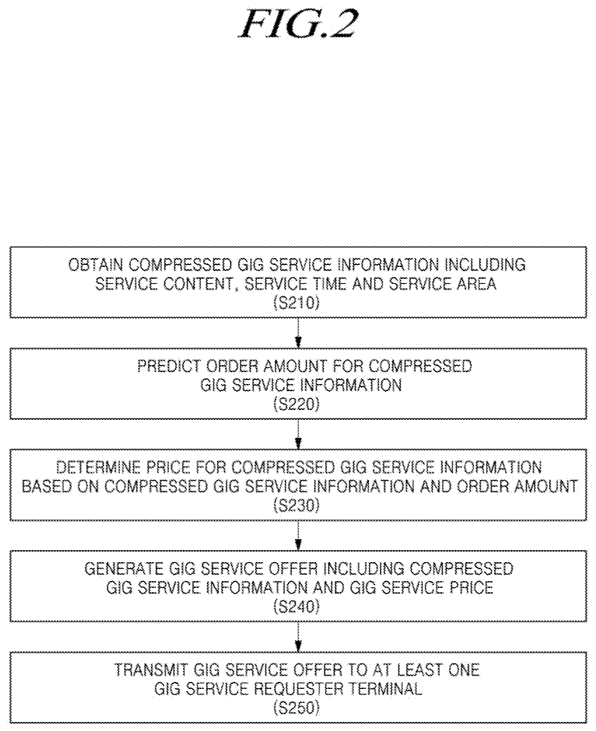

FIG. 2 is a schematic flowchart of a method for providing a compressed gig service according to an embodiment of the disclosure.

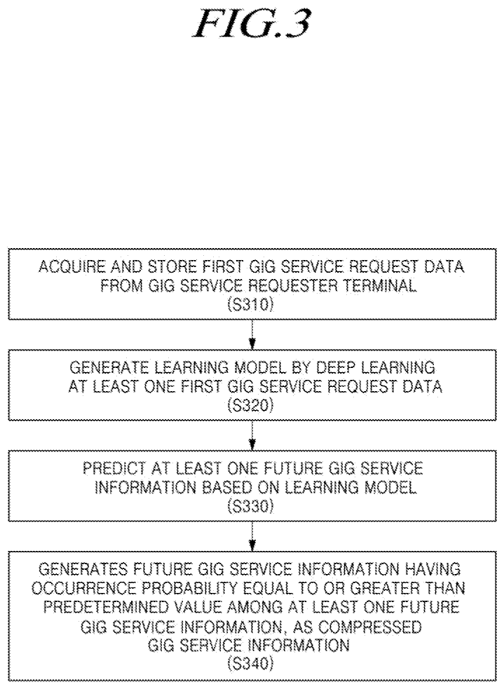

In operation S210, the gig service providing device 110 obtains compressed gig service information including a service content, a service time, and a service area. The gig service providing device 110 generates a learning model by learning gig service request data from at least one gig service requester terminal 120, predicts future gig service information based on the learning model, and obtains prediction information having an occurrence probability equal to or greater than a predetermined value from among the predicted information, as the compressed gig service information. A detailed operation of obtaining the compressed gig service information will be described later with reference to FIG. 3. The gig service request data includes at least one of a service content, a service request time, a service request area, and service requester information.

In operation S220, the gig service providing device 110 predicts an order amount for the compressed gig service information, based on the learning model.

In operation S230, the gig service providing device 110 determines a price for the compressed gig service information, based on the compressed gig service information and the order amount. In determining the price for the compressed gig service information, the gig service providing device 110 may determine an optimum price by applying a discount rate step by step according to the order amount, but it will be obvious to those skilled in the art that various algorithms may be applied herein.

In operation S240, the gig service providing device 110 generates a gig service offer including the compressed gig service information and a gig service price.

In operation S250, the gig service providing device 110 transmits the gig service offer to at least one gig service requester terminal 120. It will be obvious to those skilled in the art that the transmission may be performed by various means such as e.g., a text message application and an order application, and the disclosure is not limited to any specific means. Based on the learning model, the gig service providing device 110 may select at least one gig service requester terminal 120 corresponding to a gig service requester having a similar gig service request history to transmit the gig service offer.

The gig service providing device 110 according to the embodiment receives second gig service request data for the gig service offer from the gig service requester terminal 120 (not shown). The gig service providing device 110 may update the learning model based on the second gig service request data (not shown). The gig service providing device 110 processes a gig service for the received second gig service request data (not shown). In such a circumstance, the gig service providing device 110 may generate a work schedule of the gig worker to handle the gig service, based on the second gig service request data (not shown).

The gig service providing device 110 may receive a bid for a gig service price from at least one gig worker capable of handling the gig service based on the second gig service request data (not shown). The gig service providing device 110 may select a gig worker who has offered the lowest price from among the bids for the gig service price, as the gig worker to handle the gig service, and may generate a work schedule of the selected worker based on the second gig service request data (not shown).

FIG. 3 is a schematic flowchart of obtaining compressed gig service information according to an embodiment of the disclosure.

In operation S310, the gig service providing device 110 acquires first gig service request data from the gig service requester terminal 120 and stores the same. The first gig service request data includes at least one of a service content, a service request time, a service request area, and service requester information.

In operation S320, the gig service providing device 110 generates a learning model by deep learning the at least one first gig service request data. According to an embodiment of the disclosure, the learning model may be trained by deep learning, and may use at least one of a machine learning algorithm such as random forest, deep neural network (DNN), convolutional neural network (CNN), recurrent neural network (RNN), restricted Boltzmann machine (RBM), deep belief network (DBN), or deep Q-networks (DQN), for the deep learning, but the disclosure is not limited thereto.

In operation S330, the gig service providing device 110 predicts at least one future gig service information, based on the learning model. The future gig service information according to the embodiment includes at least three service elements of a service content, a service time, and a service area. In predicting the future gig service information according to the embodiment, it is obvious to one of ordinary skill in the art that one or two of the three service elements may be fixed and values of the remaining elements may be predicted, but the elements to be predicted and the number thereof are not limited thereto. Further, in prediction of the future gig service information according to an embodiment of the disclosure, the gig service providing device 110 may predict the future gig service information inclusive of at least one additional element of the quantity of orders, prices, information on population of a service area, seasons, weather and so on.

According to the embodiment, the future gig service information may be predicted through priori probability and likelihood. Specifically, the future gig service information may be predicted by the function that maximizes the likelihood value L of the priori probability model (P_model) of modeling the distribution in which the existing gig service data occurred, and may be described as in the follow definition:
L (model; service content, service time, service area)=P_model (service content, service time, service area)

Prediction Function=argmax_{model}L(model;data)

It will be apparent to those skilled in the art that the prediction of the future gig service information according to the embodiment may use at least one of Hidden Markov Model (HMM) and Bayesian Probability, but this disclosure is not limited thereto.

In operation S340, the gig service providing device 110 generates, as the compressed gig service information, the future gig service information having an occurrence probability equal to or greater than a predetermined value among the at least one future gig service information. The gig service providing device 110 according to an embodiment of the disclosure may obtain, as the compressed gig service information, a section in which the three service elements are most aggregated, that is, a section having the highest probability of a set of three elements, among the future gig service information predicted in operation S330, but it will be obvious to those skilled in the art that another algorithm capable of compressing the gig service information may be used.

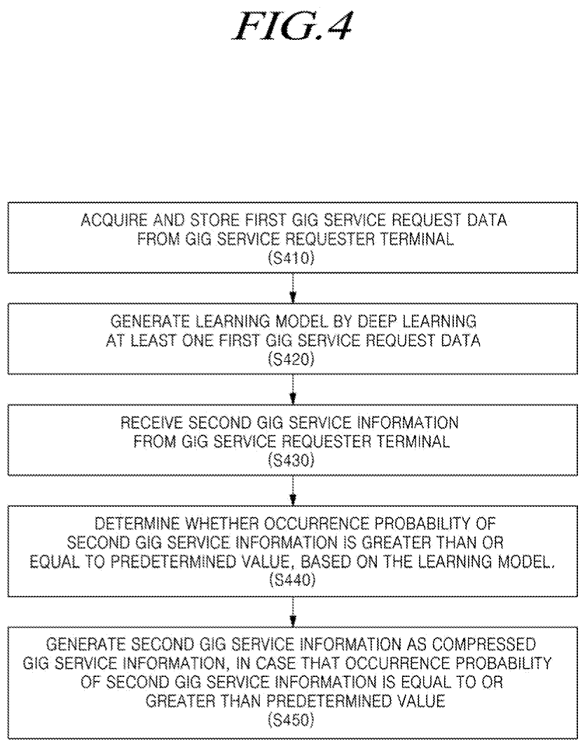

FIG. 4 is a schematic flowchart of obtaining compressed gig service information according to another embodiment of the disclosure.

In operation S410, the gig service providing device 110 acquires and stores first gig service request data from the gig service requester terminal 120. The first gig service request data includes at least one of a service content, a service request time, a service request area, and service requester information.

In operation S420, the gig service providing device 110 generates a learning model by deep learning the at least one first gig service request data. According to an embodiment of the disclosure, the learning model is trained by deep learning, and uses at least one of machine learning algorithm such as random forest, deep neural network (DNN), convolutional neural network (CNN), recurrent neural network (RNN), restricted Boltzmann machine (RBM), deep belief network (DBN), or deep Q-networks (DQN) for the deep learning, but the disclosure is not limited thereto.

In operation S430, the gig service providing device 110 receives second gig service information from the gig service requester terminal 120. According to the embodiment, the gig service requester configures the gig service information and provides a gig service offer to a plurality of gig service requesters, thereby enabling compression into the gig service configured by the gig service requester, maximizing the number of orders handled by the gig worker per hour, and improving the efficiency of the gig service.

According to the embodiment, the gig service providing device 110 may generate recommended gig service information, which may become a candidate for the gig service requester terminal 120 to generate the second gig service information, based on the learning model, and may transmit the recommended gig service information to the gig service requester terminal 120.

In operation S440, the gig service providing device 110 determines whether the occurrence probability of the second gig service information is greater than or equal to a predetermined value, based on the learning model.

In operation S450, in case that the occurrence probability of the second gig service information is equal to or greater than a predetermined value, the gig service providing device 110 generates the second gig service information as the compressed gig service information.

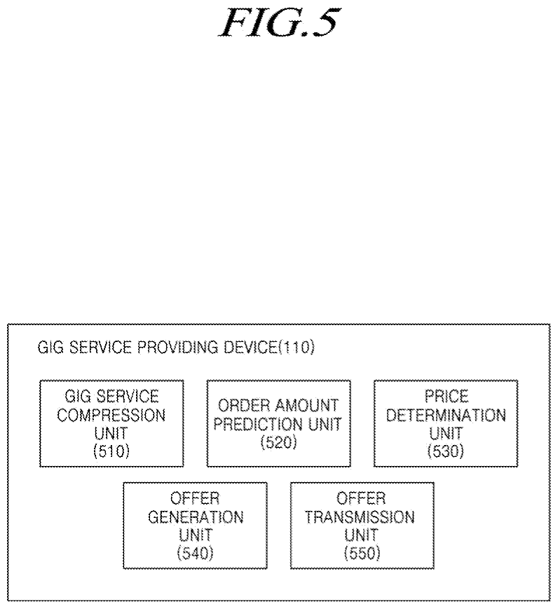

FIG. 5 is a schematic block diagram of a compressed gig service providing device according to an embodiment of the disclosure.

According to an embodiment of the disclosure, the gig service providing device 110 includes a gig service compression unit 510, an order amount prediction unit 520, a price determination unit 530, an offer generation unit 540, and an offer transmission unit 550. According to an embodiment of the disclosure, the gig service providing device 110 may further include at least one of a gig service processing unit (not shown), a learning model updating unit (not shown), a work schedule generation unit (not shown), a price bidding unit (not shown), and a gig worker selection unit (not shown).

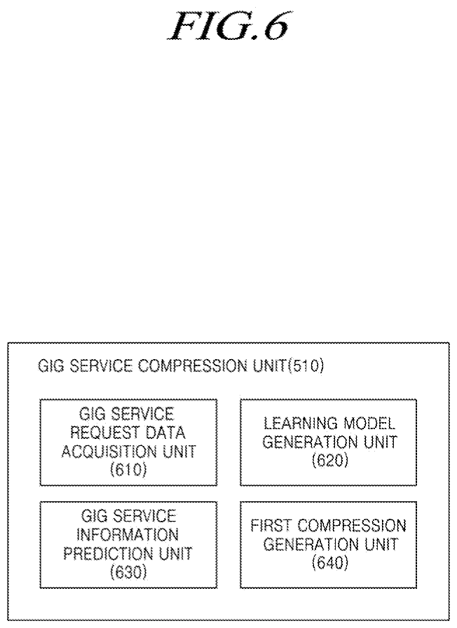

The gig service compression unit 510 acquires compressed gig service information including a service content, a service time, and a service area. FIG. 6 is a schematic block diagram of a gig service compression unit 510 according to an embodiment of the disclosure. According to an embodiment of the disclosure, the gig service compression unit 510 includes a gig service request data acquisition unit 610, a learning model generation unit 620, a gig service information prediction unit 630, and a first compression generation unit 640.

The gig service request data acquisition unit 610 acquires and stores the first gig service request data from the gig service requester terminal 120. The first gig service request data includes at least one of a service content, a service request time, a service request area, and service requester information.

The learning model generation unit 620 generates a learning model by deep learning the at least one first gig service request data. According to an embodiment of the disclosure, the learning model is trained by deep learning, and uses at least one of machine learning algorithm such as random forest, deep neural network (DNN), convolutional neural networks (CNN), recurrent neural network (RNN), restricted Boltzmann machine (RBM), deep belief network (DBN), or deep Q-networks (DQN) for the deep learning, but the disclosure is not limited thereto.

The gig service information prediction unit 630 predicts at least one future gig service information based on the learning model. According to the embodiment, the future gig service information includes three service elements inclusive of a service content, a service time, and a service area. According to the embodiment, in predicting the future gig service information, it will be obvious to one of ordinary skill in the art that one or two of the three service elements may be fixed and values of the remaining elements may be predicted, but the elements to be predicted and the number thereof are not limited. Further, according to the embodiment, in prediction of the future gig service information according to the embodiment, the gig service information prediction unit 630 may predict the future gig service information inclusive of at least one additional element such as e.g., the quantity of orders, prices, information on population of a service area, and seasons, weather and so on.

According to an embodiment, the future gig service information may be predicted through the priori probability and the likelihood. Specifically, the future gig service information may be predicted by a function that maximizes the likelihood value L of the priori probability model (P_model) modeling the distribution in which the existing gig service data occurred, and may be described as in the following definition:

L (model; service content, service time, service area)=P_model (service content, service time, service area)

Prediction Function=argmax_{model}L(model;data)

It will be apparent to those skilled in the art that the prediction of the future gig service information according to the embodiment may use at least one of the Hidden Markov Model (HMM) and the Bayesian Probability, but the disclosure is not limited thereto.

The first compression generation unit 640 generates the future gig service information having an occurrence probability equal to or greater than a predetermined value among the at least one future gig service information predicted, as the compressed gig service information. According to the embodiment, the first compression generation unit 640 may obtain, as the compressed gig service information, a section in which the three service elements are most aggregated, that is, a section having the highest probability of a set of three elements, from among the future gig service information predicted by the gig service information prediction unit 630, but it will be obvious to those skilled in the art that another algorithm capable of compressing the gig service information may be used.

The order amount prediction unit 520 predicts an order amount for the compressed gig service information. The order amount prediction unit 520 may predict the order amount for the compressed gig service information based on the learning model.

The price determination unit 530 determines a price for the compressed gig service information based on the compressed gig service information and the order amount. In determining the price for the compressed gig service information, the price determination unit 530 may determine the optimized price by applying a discount rate step by step according to the order amount, but it will be apparent to those skilled in the art that various algorithms for determining the price may be applied.

The offer generation unit 540 generates a gig service offer including the compressed gig service information and the gig service price.

The offer transmission unit 550 transmits the gig service offer to at least one gig service requester terminal 120. It will be apparent to those skilled in the art that the offer transmission unit 550 may transmit an offer using various means such as e.g., a text message application and an order application, and the disclosure is not limited to its specific means. The offer transmission unit 550 may transmit the gig service offer by selecting at least one gig service requester terminal 120 corresponding to a gig service requester having a similar gig service request history, based on the learning model.

The gig service request data acquisition unit 610 receives second gig service request data for the gig service offer from the gig service requester terminal 120.

The learning model updating unit (not shown) updates the learning model based on the second gig service request data.

The gig service processing unit (not shown) processes the gig service for the received second gig service request data.

The work schedule generation unit (not shown) generates a work schedule of a gig worker to handle the gig service based on the second gig service request data.

The price bidding unit (not shown) receives a bid for the gig service price from at least one gig worker capable of processing the gig service, based on the second gig service request data.

The gig worker selection unit (not shown) selects a gig worker who has offered the lowest price among the bids for the gig service price, as a gig worker to handle the gig service.

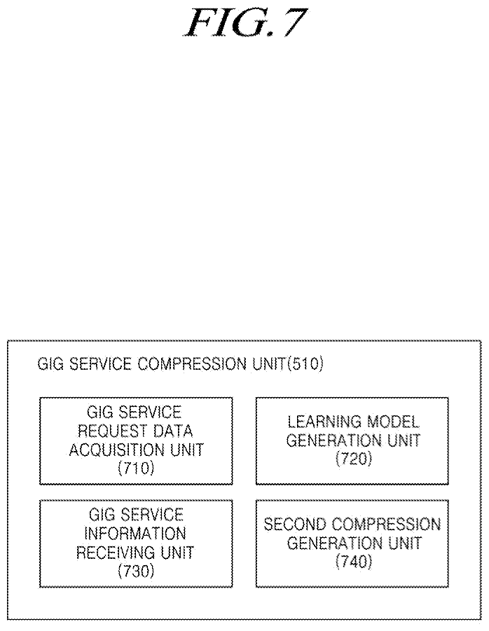

FIG. 7 is a schematic block diagram of a gig service compression unit according to another embodiment of the disclosure.

According to another embodiment of the disclosure, the gig service compression unit 510 includes a gig service request data acquisition unit 710, a learning model generation unit 720, a gig service information receiving unit 730, and a second compression generation unit 740.

The gig service request data acquisition unit 710 acquires and stores the first gig service request data from the gig service requester terminal 120. The first gig service request data includes at least one of a service content, a service request time, a service request area, and service requester information.

The learning model generation unit 720 generates a learning model by deep learning the at least one first gig service request data. According to an embodiment of the disclosure, the learning model is trained by deep learning, and uses at least one of machine learning algorithm such as random forest, deep neural network (DNN), convolutional neural networks (CNN), recurrent neural network (RNN), restricted Boltzmann machine (RBM), deep belief network (DBN), or deep Q-networks (DQN) for the deep learning, but the disclosure is not limited thereto.

The gig service information receiving unit 730 receives second gig service information from the gig service requester terminal 120. The gig service providing device 110 according to the embodiment may generate recommended gig service information, which may be a candidate for the gig service requester terminal 120 to generate second gig service information, based on the learning model, and may transmit the recommended gig service information to the gig service requester terminal 120.

The second compression generation unit 740 determines whether an occurrence probability of the second gig service information is greater than or equal to a predetermined value based on the learning model, and generates the second gig service information as the compressed gig service information, in case that the occurrence probability of the second gig service information is greater than or equal to the predetermined value.

While preferred embodiments of the present invention have been described in detail heretofore, the scope of the present invention is not limited thereto, and various modifications and any other equivalent embodiments are possible. Therefore, the true technical scope of protection of the disclosure shall be defined by the appended claims.

For example, a device according to an example embodiment of the disclosure may include a bus coupled to units of each device as illustrated, at least one processor operatively coupled to the bus, and a memory coupled to the bus to store instructions, received messages, or generated messages and coupled to at least one processor to perform the aforementioned instructions.

Further, a system according to the disclosure may be implemented with computer-readable codes on a computer-readable recording medium. The computer-readable recording medium may include any kinds of recording devices in which data readable by a computer system is stored. The computer-readable recording medium may include a magnetic storage medium (e.g., ROM, floppy disk, hard disk, etc.) and an optical reading medium (e.g., CD-ROM, DVD, etc.). The computer-readable recording medium may be distributed over a network-connected computer system to store and execute computer-readable codes in a distributed manner.

1. A method for providing a compressed gig service, comprising:
obtaining compressed gig service information including a service content, a service time, and a service area;
predicting an order amount for the compressed gig service information;
determining a price for the compressed gig service information, based on the compressed gig service information and the order amount;
generating a gig service offer including the compressed gig service information and the gig service price; and
transmitting the gig service offer to at least one gig service requester terminal.

2. The method of claim 1, wherein obtaining the compressed gig service information comprises:
obtaining and storing first gig service request data from the gig service requester terminal, and
generating a learning model by deep learning the at least one first gig service request data.

3. The method of claim 2, wherein obtaining the compressed gig service information comprises:
predicting at least one future gig service information, based on the learning model, and
generating future gig service information having an occurrence probability equal to or greater than a predetermined value among the at least one future gig service information, as the compressed gig service information.

4. The method of claim 2, wherein the first gig service request data comprises at least one of a service content, a service request time, a service request area, and service requester information.

5. The method of claim 2, wherein predicting the order amount for the compressed gig service information comprises predicting the order amount for the compressed gig service information based on the learning model.

6. The method of claim 2, further comprising:
receiving second gig service request data for the gig service offer from the gig service requester terminal, and
processing the gig service for the received second gig service request data.

7. The method of claim 6, further comprising updating the learning model, based on the second gig service request data.

8. The method of claim 6, further comprising generating a work schedule of a gig worker to handle the gig service, based on the second gig service request data.

9. The method of claim 6, further comprising:
receiving a bid for a gig service price from at least one gig worker capable of processing the gig service, based on the second gig service request data, and
selecting a gig worker who has offered a lowest price among the bids for the gig service price, as the gig worker to handle the gig service.

10. The method of claim 2, wherein obtaining the compressed gig service information further comprises:
receiving second gig service information from the gig service requester terminal;
based on the learning model, determining whether an occurrence probability of the second gig service information is greater than or equal to a predetermined value; and
in case that the occurrence probability of the second gig service information is greater than or equal to a predetermined value, generating the second gig service information as the compressed gig service information.

11. A device for providing a compressed gig service device, comprising:
a gig service compression unit configured to obtain compressed gig service information including a service content, a service time, and a service area;
an order amount prediction unit configured to predict an order amount for the compressed gig service information;
a price determination unit configured to determine a price for the compressed gig service information, based on the compressed gig service information and the order amount;
an offer generation unit configured to generate a gig service offer including the compressed gig service information and the gig service price; and
an offer transmission unit configured to transmit the gig service offer to at least one gig service requester terminal.

12. The device of claim 11, wherein the gig service compression unit comprises:
a gig service request data acquisition unit configured to acquire and store first gig service request data from the gig service requester terminal, and
a learning model generation unit configured to generate a learning model by deep learning the at least one first gig service request data.

13. The device of claim 12, wherein the gig service compression unit comprises:
a gig service information prediction unit configured to predict at least one future gig service information, based on the learning model, and
a first compression generation unit configured to generate future gig service information having an occurrence probability equal to or greater than a predetermined value among the at least one future gig service information, as the compressed gig service information.

14. The device of claim 12, wherein the gig service request data acquisition unit receives second gig service request data for the gig service offer from the gig service requester terminal, and
wherein the device further comprises a gig service processing unit configured to handle the gig service for the received second gig service request data.

15. The device of claim 14, further comprising:
a price bidding unit configured to receive a bid for a gig service price from at least one gig worker capable of handling the gig service, based on the second gig service request data, and
a gig worker selection unit configured to select a gig worker who has offered a lowest price among the bids for the gig service price, as the gig worker to handle the gig service.
